(19) United States
(12) Patent Application Publication
(10) Pub. No.: US 2025/0201962 A1
(43) Pub. Date: Jun. 19, 2025

(54) AEROSOL PROVISION DEVICE

(71) Applicant: NICOVENTURES TRADING LIMITED, London (GB)

(72) Inventor: Robert GRUAR, London (GB)

(21) Appl. No.: 18/847,399

(22) PCT Filed: Mar. 17, 2023
(86) PCT No.: PCT/EP2023/056971

§ 371 Date: Sep. 16, 2024

(30) Foreign Application Priority Data
Mar. 17, 2022 (GB) 2203757.6

(51) Int. Cl. H01M 10/6556; A24F 40/20; A24F 40/465; A24F 40/485; A24F 40/95; H01M 10/0525; H01M 10/613; H01M 50/105; H01M 50/121

(52) U.S. Cl. CPC H01M 10/6556; A24F 40/485; H01M 10/0525; H01M 10/613; H01M 50/105; H01M 50/121; A24F 40/20; A24F 40/465; A24F 40/95; H01M 2220/30

(57) ABSTRACT

An aerosol provision device includes an aerosol generator and a power source connected to the aerosol generator. The power source includes a pouch cell.

### RELATED APPLICATIONS

The present application is a National Phase entry of PCT Application No. PCT/EP2023/056971 filed Mar. 17, 2023, which claims priority to GB Application No. 2203757.6 filed Mar. 17, 2022, each of which is hereby incorporated by reference in their entirety.

### TECHNICAL FIELD

The present invention relates to an aerosol provision device, an aerosol provision system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Conventional aerosol provision devices comprise a cylindrical heating chamber into which a rod shaped consumable is inserted.

It is desired to provide an improved aerosol provision device.

### SUMMARY

According to an aspect there is provided an aerosol provision device comprising:
an aerosol generator; and
a power source connected to the aerosol generator, wherein the power source comprises a pouch cell.

The use of a pouch cell is beneficial as it allows the weight of the power source to be reduced compared to a conventional battery.

In an aerosol provision device comprising a power source, the power source may become hot during charging or discharging. This may cause the temperature of the power source to be outside a desired operating range, which may lead to decreased performance of the power source or damage to the power source.

According to various the aerosol provision device may further comprise a heat dissipation device for cooling the power source. The heat dissipation device may comprise a heat dissipation formation thermally connected to the power source and arranged adjacent to one or more airflow channels. Heat from the power source is conducted to the heat dissipation formation, and then into air flowing in the one or more air flow channels. This provides active cooling of the power source. According to various embodiments the heat dissipation formation is arranged adjacent to the one or more air flow channels and hence increased efficiency of heat transfer is achieved due to the speed of the air flowing past the heat dissipation formation when a user draws on the device.

It will be appreciated, therefore, that the provision of a heat dissipation device comprising a heat dissipation formation arranged adjacent to the air flow channel in an aerosol provision device having a power source is particularly beneficial.

Optionally, the aerosol provision device comprises a heat dissipation device for cooling the pouch cell.

Optionally, the pouch cell comprises a lithium-ion battery (LIB).

Optionally, the lithium-ion battery comprises a positive electrode and a negative electrode. The positive electrode may comprise an intercalated lithium compound. The negative electrode may comprise graphite.

Optionally, the pouch cell comprises an outer housing, wherein the outer housing comprises a plastic.

Optionally, the plastic comprises a polyamide or a polyester.

Optionally, the heat dissipation device comprises one or more thermally conductive tracks.

Optionally, the heat dissipation device further comprises a heat dissipation formation thermally connected to the pouch cell. Optionally, the heat dissipation device is arranged adjacent one or more airflow channels.

Optionally, the heat dissipation formation comprises a rib connected to the thermally conductive track and disposed in the one or more airflow channels.

Optionally, the one or more thermally conductive tracks are arranged to transfer heat energy from the pouch cell to air flowing through the one or more airflow channels via the heat dissipation formation in order to cool the pouch cell.

Optionally, the aerosol provision device comprises a mouthpiece or air inlet and wherein the one or more airflow channels direct air from the mouthpiece or air inlet into a heating chamber arranged to receive an aerosol generating article.

Optionally, the pouch cell comprises a hermetically sealed in a chamber to prevent any gas emitted by the pouch cell being released into the one or more airflow channels.

Optionally, the one or more airflow channels are disposed outside the hermetically sealed chamber and the thermally conductive track extends from the interior of the hermetically sealed chamber to the exterior of the hermetically sealed chamber.

According to an aspect there is provided an aerosol provision device comprising:
one or more air flow channels;
a power source; and
a heat dissipation device for cooling the power source, the heat dissipation device comprising a heat dissipation formation thermally connected to the power source and arranged adjacent to the one or more air flow channels.

Optionally, the heat dissipation device comprises one or more thermally conductive tracks.

Optionally, the heat dissipation formation is connected to the power source via the one or more thermally conductive tracks.

Optionally, the one or more thermally conductive tracks are at least partially received in a void defined by the power source.

Optionally, the power source comprises a pouch cell.

Optionally, the power source is hermetically sealed in a chamber to prevent any gas emitted by the pouch cell being released into the one or more airflow channels.

Optionally, the one or more airflow channels are disposed outside the hermetically sealed chamber and the one or more thermally conductive tracks extend from the interior of the hermetically sealed chamber to the exterior of the hermetically sealed chamber.

Optionally, the heat dissipation formation comprises a rib.

Optionally, the aerosol provision device comprises a flow channel member defining the one or more air flow channels. Optionally, the heat dissipation formation comprises a thermally conductive coating on the flow channel member.

According to another aspect there is provided an aerosol provision system comprising:
an aerosol provision device as described above; and
an aerosol generating article comprising aerosol generating material.

According to another aspect there is provided a method of generating an aerosol comprising:
providing an aerosol provision device comprising an aerosol generator and a power source connected to the aerosol generator, wherein the power source comprises a pouch cell;
inserting an aerosol generating article into the aerosol provision device; and
supplying power from the power source to the aerosol generator.

### BRIEF DESCRIPTION OF THE DRAWINGS

Various embodiments will now be described by way of example only and with reference to the accompanying drawings in which:

FIG. 1 shows a perspective view of an aerosol provision device and charging unit according to an embodiment;

FIG. 2 shows a schematic cross-sectional view of an aerosol provision device according to an embodiment;

FIG. 3 shows a schematic cross sectional view of an aerosol provision device according to another embodiment; and

FIG. 4 shows a schematic cross sectional view of an aerosol provision device according to another embodiment.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

According to various embodiments the aerosol provision device may comprise one or more inductors and a susceptor which is arranged to be heated by the one or more inductors.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Various embodiments will now be described in more detail.

According to various embodiments an aerosol provision device is provided which may be arranged to be chargeable by a charging unit.

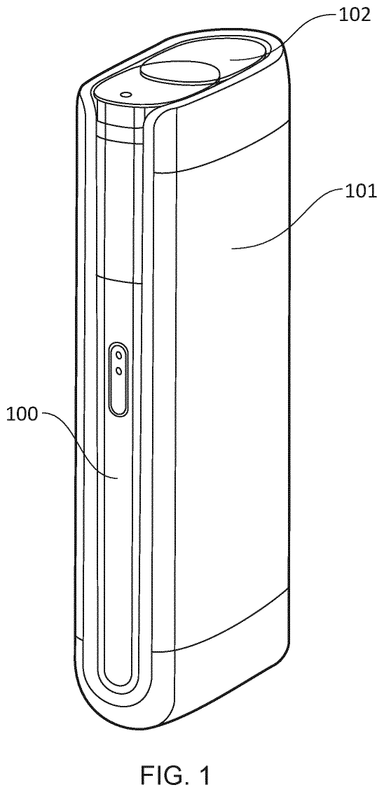

FIG. 1 shows an aerosol provision device 100 according to an embodiment shown located within an elongate cavity of a charging unit 101. The charging unit 101 may comprise a power source (not shown). The power source may include, for example, a battery (single-use or rechargeable), a rechargeable super capacitor, a rechargeable solid-state battery (SSB), a rechargeable lithium-ion battery (LiB) or the like, a hermetically sealed battery, a pouch cell battery or some combination thereof. Whilst the aerosol provision device 100 is shown in combination with a charging unit 101, it will be appreciated that the aerosol provision device 100 may be provided with power by any other means. For example, a power source provided with aerosol provision device 100 may be charged by plugging a power supply into the aerosol provision device 100, or the power source may be replaceable, e.g. in the form of a replaceable battery.

As will be described in more detail below, according to various embodiments the aerosol provision device 100 may comprise a power source and the power source may comprise a pouch cell. The pouch cell may comprise a lithium ion battery provided in a plastic outer housing.

The aerosol provision device 100 may be left in the charging unit 101 for a predetermined time in order to allow sufficient charging of the aerosol provision device 100. For example, the charging unit 101 may be arranged to charge the aerosol provision device 100 to full charge in a time of <10 mins, 10-20 mins, 20-30 mins, 30-40 mins, 40-50 mins, 50-60 mins or >60 mins.

The charging unit 101 and/or the aerosol provision device 100 may optionally have an indicator to give a visual or other representation to the user of the charging level of the aerosol provision device 100. Additionally, there may be a separate indicator to give a visual representation of the charge level of the charging unit 101. The current charge level of the aerosol provision device 100 and/or the charging unit 101 may be determined by control means disposed in the aerosol provision device 100 and/or the charging unit 101.

The visual indicator may comprise one or more light-emitting diodes (LEDs). However, other embodiments are contemplated where the visual indicator may be replaced by an audio indicator (e.g. a speaker) or a haptic indicator.

The aerosol provision device 100 may comprise an outer housing which may have a tubular and/or cylindrical shape. However, other embodiments are envisaged wherein the aerosol provision device 100 may take other desired forms e.g. the aerosol provision device 100 may be boxed shaped. According to an embodiment the outer housing of the aerosol provision device 100 may comprise an electrical insulator and may, for example, be formed of polyetheretherketone (“PEEK”).

According to an embodiment the distal end of the aerosol provision device 100 may comprise one or more orientation features and/or one or more magnets for securing the distal end of the aerosol provision device 100 to a base portion of the charging unit 101.

The aerosol provision device 100 may be inserted into the cavity of the charging unit 101 in order to recharge the aerosol provision device 100 by receiving electrical power from the charging unit 101. The charging unit 101 may comprise an internal battery to provide electrical power to the aerosol provision device 100. The charging unit 101 may also be connected to an external source of electrical power.

The charging unit 101 may comprise a lid or cover 102 which may be slid by a user between an open and closed position. The lid or cover 102 is provided at the entrance to the cavity which is provided within the charging unit 101 and which is configured to receive the aerosol provision device 100.

The aerosol provision device 100 includes an aerosol generator for generating aerosol from aerosol generating material. According to an embodiment the aerosol provision device 100 comprises a resistive heater for heating an aerosol generating article. However, other embodiments are contemplated wherein the aerosol provision device 100 may comprise an inductive heating unit.

When the lid or cover 102 is in the open position an opening to the cavity is exposed thereby enabling a user to either remove the aerosol provision device 100 from the charging unit 101 (in order to use the aerosol provision device 100) or alternatively to insert the aerosol provision device 100 into the charging unit 101 (in order to charge the aerosol provision device 100).

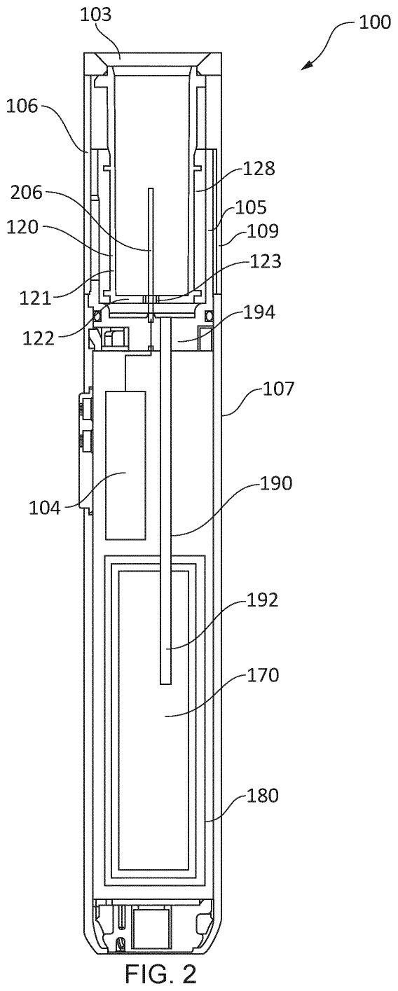

FIG. 2 shows a cross sectional view of the aerosol provision device 100 according to an embodiment. The aerosol provision device 100 includes a heating element 206 for heating an aerosol generating article. The heating element 206 may comprise a resistive heating element.

The aerosol provision device 100 comprises a main housing 105 and an outer housing 107. The main housing 105 comprises a tubular wall extending from an end of the outer housing 107. The resistive heating element 106 projects within the main housing 105. The aerosol provision device 100 further comprises a removable cap 106 which may be magnetically retained to the main housing 105. In embodiments, the removable cap 106 may be releasably retained to the main housing 105 by other means, such as a push fit, clips or a screw thread.

The aerosol provision device 100 comprises electronic control circuitry 104. The electronic control circuitry 104 is disposed within the outer housing 107. The electronic control circuitry 104 may be configured to control the heating element 206. The electronic control circuitry 104 may comprise a printed circuit board.

As shown in FIG. 2, the removable cap 106 includes a receptacle 120 for receiving a consumable or aerosol generating article. In use, an aerosol generating article is inserted into the receptacle 120. The removable cap 106 also includes an outer casing 109. The outer casing is joined to the receptacle 120. The outer casing 109 is arranged to fit at least partially over the main housing 105. In use, the main housing 105 is partly received between the outer casing 109 and the receptacle 120. The receptacle 120 and the outer casing 109 may comprise a single component. In other embodiments, the receptacle 120 and the outer casing 109 may comprise separate components which are permanently joined together, for example by an adhesive or by welding. In other embodiments, the receptacle 120 and the outer casing 109 may be separable.

The receptacle 120 may comprise a tubular housing 121 and a base portion 122. The base portion 122 of the receptacle 120 comprises an aperture 123 and the resistive heating element 206 is arranged to project through the aperture 123.

A space is defined between the outer casing 109 and the receptacle 120 through which air flows in use. In other embodiments, apertures may be provided in the outer casing 109 or the receptacle 120 to provide airflow.

An air flow channel 128 is defined between the receptacle 120 and the main housing 105. The aperture 123 of the base portion 122 communicates with the air flow channel 128.

An aerosol generating article may be inserted into the aerosol provision device 100 by inserting the aerosol generating article through an opening 103 in the removable cap 106 and then inserting the aerosol generating article into the receptacle 120 and onto the heating element 206.

The heating element 206 may have a blade like profile and in use an aerosol generating article may be forced onto the heating element 206 so that the blade like profile of the heating element 206 inserts into a distal end of the aerosol generating article. The heating element 206 may be arranged to internally heat the aerosol generating article.

In use, an end of the aerosol generating article protrudes from the aerosol provision device 100. The user draws on the end of the aerosol generating article, and air flows into and along the air flow channel 128, out of the aperture 123 of the base portion 122 and into the other end of the aerosol generating article.

At the end of a session of use, when an aerosol generating article has been exhausted, the removable cap 106 may then be detached from the main housing 105. It will be understood that the process of detaching the removable cap 106 will have the effect that the base portion 122 of the receptacle 120 will contact a bottom face of the aerosol generating article. As the removable cap 106 is withdrawn, then the base portion 122 of the receptacle 120 will contact the distal end of the aerosol generating article and will result in the aerosol generating article being pulled off or otherwise removed from the heating element 206.

The aerosol provision device 100 includes a power source 170. The power source 170 is disposed within the outer housing 107. The power source 170 is a pouch cell. The pouch cell comprises an outer housing, wherein the outer housing comprises a plastic. The plastic comprises a polyamide or a polyester.

The pouch cell comprises a lithium ion battery 170. The lithium-ion battery 170 comprises a positive electrode and a negative electrode. The positive electrode comprises an intercalated lithium compound and the negative electrode comprises graphite.

The power source 170 may be disposed in a hermetically sealed chamber 180. The chamber 180 may comprise a compartment within the housing 107. The chamber 180 may be provided as a wrap around the power source 170 or may be a rigid casing. The chamber 180 may be defined by an assembly of multiple components joined together to form a hermetic seal. The chamber 180 may be at least partly defined by the housing 107. Other components, such as electronic components, may be disposed inside the chamber 180. One or more thermally conductive tracks 192 extend from the power source 170 out of the hermetically sealed chamber 180.

The power source 170 is electrically connected to an aerosol generator. In this embodiment, the power source 170 is electrically connected to the resistive heating element 206 to provide power to heat the heating element 206.

The provision of a lithium ion battery is desirable as it may store enough power for more than one use session of the aerosol provision device 100. The use of a pouch cell is beneficial as it allows the weight of the power source 170 to be reduced compared to a conventional battery.

The performance of batteries is temperature sensitive, particularly that of lithium ion batteries. It is therefore desirable to maintain the power source 170 at a desired operating temperature to improve the performance of the power source 170 and avoid damage to the power source 170. The power source 170 generates heat when charging and discharging. It may therefore be desirable to cool the power source 170 to maintain the desired operating temperature.

The pouch cell may comprise approximately 90% active materials by weight, compared to approximately 60% active materials by weight in other battery types. This makes passive cooling of the pouch cell less efficient, as there is a smaller amount of inactive mass in the battery pack to act as a heat sink. According to various embodiments the pouch cell comprises a polymer pouch which wraps around the active materials of the cell. The polymer pouch may act as thermal insulation.

Embodiments are disclosed which are concerned with diverting heat energy away from the power source 170, in order to maintain the desired operating temperature.

According to an embodiment a heat dissipation device 190 may be provided. The heat dissipation device 190 may comprise one or more thermally conductive tracks 192. The one or more thermally conductive tracks 192 may be formed of a thermally conductive material, such as a metallic material. The one or more thermally conductive tracks 192 may comprise a one-piece component, or an assembly of more than one component. The one or more thermally conductive tracks are in contact with the power source 170 which may comprise a pouch cell. A void may be defined within the pouch cell 170, and the one or more thermally conductive tracks 192 may be disposed in the void. This provides more efficient transfer of heat from the pouch cell 170 to the one or more thermally conductive tracks 192.

The one or more thermally conductive tracks 192 may extend from the power source 170 to the air flow channel 128. In this embodiment, the thermally conductive track 192 comprises the main housing 105.

The heat dissipation device 190 comprises a heat dissipation formation 194. The heat dissipation formation 194 is arranged in or adjacent to the air flow channel 128. The heat dissipation formation 194 is arranged to conduct heat from the thermally conductive track 192 to the air passing through the air flow channel 128. According to an embodiment a heat dissipation formation 194 may be provided by at least part of the main housing 105. The heat dissipation formation 194 may partly define the air flow channel 128. In embodiments, the heat dissipation formation 194 may have substantially any shape. The heat dissipation formation 194 may comprise a coating on a surface of the air flow channel 128.

In use, a thermally conductive channel conducts heat energy from the power source 170 to the air flow channel 128 an optionally contacts a heat dissipation formation 194. Accordingly, heat energy is transferred from the power source 170 to air in the air flow channel 128 and the air is then subsequently drawn out of the aerosol provision device 100. As a result, the power source 170 may be cooled.

It will be apparent, therefore, that an aerosol provision device 100 including a heat dissipation device 190 as detailed above is beneficial, particularly when the aerosol provision device 100 includes a pouch cell 170 and it is desired to maintain the pouch cell 170 at a desired operating temperature.

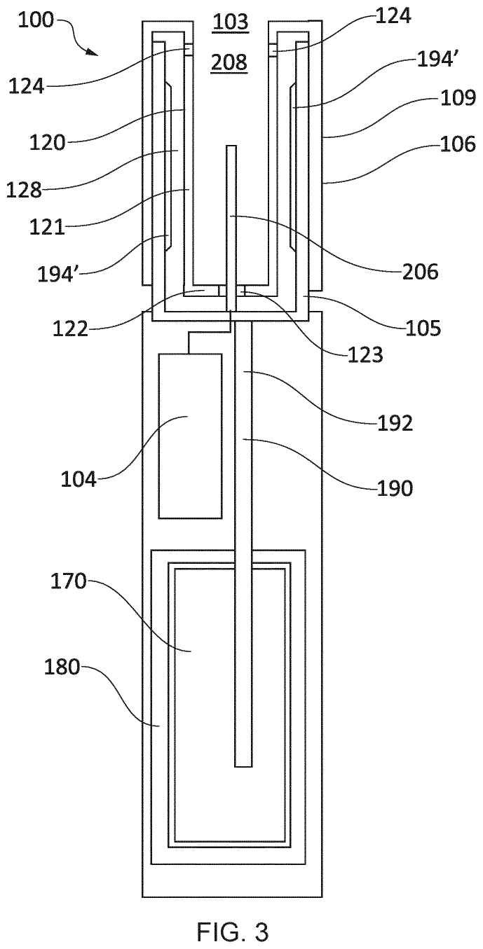

FIG. 3 shows another embodiment of an aerosol provision device 100. The aerosol provision device 100 as shown in FIG. 3 is similar to the embodiment shown in FIG. 2. According to this embodiment the heat dissipation formation further comprises a plurality of ribs 194′ attached to the main housing 105. The ribs 194′ project into the air flow channel 128. This increases the surface area of the heat dissipation formation 194 which is in contact with the air in the air flow channel 128 which increases the efficiency of thermal transfer from the one or more thermally conductive tracks 192.

An opening 103 is provided in the removable cap 106 which may lead into a heating zone 208. The removable cap 106 includes an outer casing 109.

The power source 170 is disposed in a hermetically sealed chamber 180. The chamber 180 is a compartment within the housing 107. The aerosol provision device 100 comprises electronic control circuitry 104. The electronic control circuitry 104 is disposed within the outer housing. The electronic control circuitry 104 may be configured to control the heating element 206. The electronic control circuitry 104 may comprise a printed circuit board.

The aerosol provision device 100 may further comprise a plurality of apertures 124 communicating with the air flow channel 128. The apertures 124 may be provided in the removable cap 106. The apertures 124 may be provided in the tubular housing 121 of the receptacle 120 of the removable cap 106. The apertures 124 may be located closer to a proximal end of the removable cap 106. That is, the apertures 124 are located closer to the end of the aerosol provision device 100 which the user draws on.

The aerosol provision device 100 comprises a receptacle 120 which may comprise a tubular housing 121 and a base portion 122. The base portion 122 of the receptacle 120 comprises an aperture 123 and the resistive heating element 206 is arranged to project through the aperture 123.

According to an embodiment a heat dissipation device 190 may be provided. The heat dissipation device 190 may comprise one or more thermally conductive tracks 192. The one or more thermally conductive tracks 192 may be formed of a thermally conductive material, such as a metallic material. The one or more thermally conductive tracks 192 extend from the pouch cell 170 to a portion of the main housing 105.

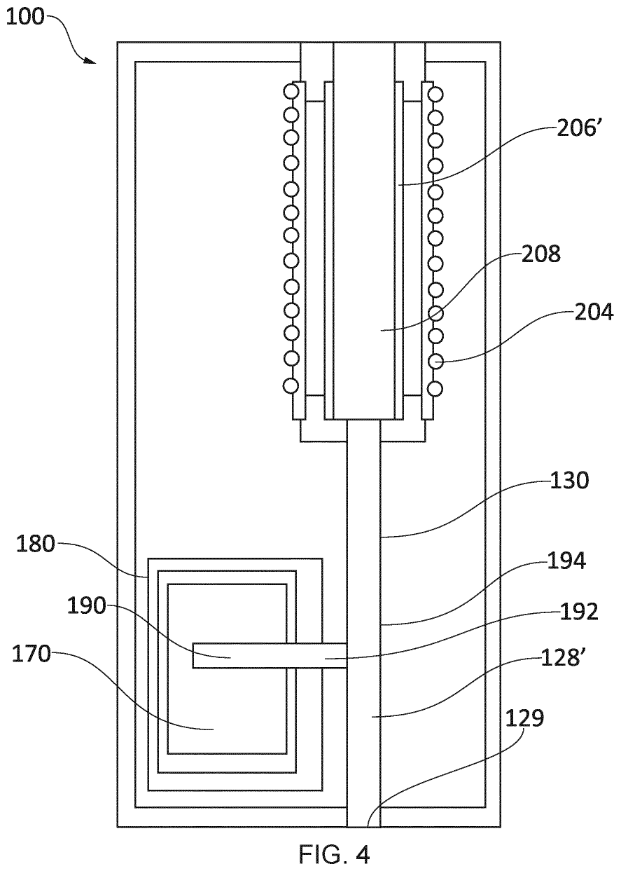

FIG. 4 shows another embodiment of an aerosol provision device 100. The heating element of this embodiment comprises a susceptor 206′ of an inductive heating arrangement. The inductive heating arrangement comprises an inductor coil 204. The susceptor 206′ may comprise a tubular member. The susceptor 206′ may define a heating zone 208. In use, an aerosol generating article is inserted into the heating zone 208.

The power source 170 is disposed in a hermetically sealed chamber 180. The chamber 180 may comprise a compartment within the outer housing. The chamber 180 may be provided as a wrap around the power source 170 or may be a rigid casing. The chamber 180 may be defined by an assembly of multiple components, joined together to form a hermetic seal. Other components, such as electronic components, may be disposed inside the chamber 180. The thermally conductive track 192 extends from the power source 170 out of the hermetically sealed chamber 180.

A heat dissipation device 190 may be provided comprising a heat dissipation formation 194.

An air flow channel 128′ may be provided which extends through the aerosol provision device 100. The air flow channel 128′ may extend from an air inlet 129 to the heating zone 208. A flow channel member 130 may be provided which extends from the heating zone 208 and which defines the air flow channel 128′. The flow channel member 130 connects to a distal end of the heating zone 208. The flow channel member 130 may extend between the heating zone 208 and the air inlet 129. The flow channel member 130 may be tubular and may define a bore. The flow channel member 130 extends in an axial direction.

According to various embodiments one or more thermally conductive tracks 192 may join to the flow channel member 130. In this embodiment, the flow channel member 130 is formed of a thermally conductive material and provides the heat dissipation formation 194. In other embodiments, the heat dissipation formation 194 may comprise a thermally conductive coating on at least a portion of an inner surface of the flow channel member 130. The thermally conductive coating may extend along substantially the entire length of the flow channel member 130. Increased efficiency of heat transfer is thus achieved due to the speed of the air flowing past the heat dissipation formation when a user draws on the device.

According to various embodiments an aerosol provision device is provided having a power source comprising a pouch cell. The pouch cell is beneficial as it allows the weight of the power source to be reduced compared to a conventional battery. A heat dissipation device may be provided in order to cool the pouch cell.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
an aerosol generator; and
a power source connected to the aerosol generator, wherein the power source comprises a pouch cell.

2. An aerosol provision device as claimed in claim 1, further comprising a heat dissipation device for cooling the pouch cell.

3. An aerosol provision device as claimed in claim 1, wherein the pouch cell comprises a lithium-ion battery (LIB).

4. An aerosol provision device as claimed in claim 3, wherein the lithium-ion battery comprises a positive electrode and a negative electrode, wherein the positive electrode comprises an intercalated lithium compound and the negative electrode comprises graphite.

5. An aerosol provision device as claimed in claim 1, wherein the pouch cell comprises an outer housing, wherein the outer housing comprises a plastic.

6. (canceled)

7. An aerosol provision device as claimed in claim 2, wherein the heat dissipation device comprises one or more thermally conductive tracks.

8. An aerosol provision device as claimed in claim 7, wherein the heat dissipation device further comprises a heat dissipation formation thermally connected to the pouch cell and arranged in or adjacent one or more airflow channels.

9. An aerosol provision device as claimed in claim 8, wherein the heat dissipation formation comprises a rib connected to the thermally conductive track and disposed in the one or more airflow channels.

10. An aerosol provision device as claimed in claim 8, wherein the one or more thermally conductive tracks are arranged to transfer heat energy from the pouch cell to air flowing through the one or more airflow channels via the heat dissipation formation in order to cool the pouch cell.

11. (canceled)

12. An aerosol provision device as claimed in claim 1, wherein the pouch cell is hermetically sealed in a chamber to prevent any gas emitted by the pouch cell being released into one or more airflow channels.

13. An aerosol provision device as claimed in claim 12, wherein the one or more airflow channels are disposed outside the hermetically sealed chamber and the thermally conductive track extends from the interior of the hermetically sealed chamber to the exterior of the hermetically sealed chamber.

14. An aerosol provision device comprising:
one or more air flow channels;
a power source; and
a heat dissipation device for cooling the power source, the heat dissipation device comprising a heat dissipation formation thermally connected to the power source and arranged in or adjacent to the one or more air flow channels.

15. An aerosol provision device as claimed in claim 14, wherein the heat dissipation device comprises one or more thermally conductive tracks.

16. An aerosol provision device as claimed in claim 15, wherein the heat dissipation formation is connected to the power source via the one or more thermally conductive tracks.

17. An aerosol provision device as claimed in claim 16, wherein the one or more thermally conductive tracks are at least partially received in a void defined by the power source.

18. An aerosol provision device as claimed in claim 14, wherein the power source comprises a pouch cell.

19. An aerosol provision device as claimed in claim 14, wherein the power source is hermetically sealed in a chamber to prevent any gas emitted by the pouch cell being released into the one or more airflow channels.

20. An aerosol provision device as claimed in claim 19, wherein the one or more airflow channels are disposed outside the hermetically sealed chamber and the one or more thermally conductive tracks extend from the interior of the hermetically sealed chamber to the exterior of the hermetically sealed chamber.

21. (canceled)

22. An aerosol provision device as claimed in claim 14, wherein the aerosol provision device comprises a flow channel member defining the one or more air flow channels and the heat dissipation formation comprises a thermally conductive coating on the flow channel member.

23. An aerosol provision system comprising:
an aerosol provision device as claimed in claim 1; and
an aerosol generating article comprising aerosol generating material.

24. (canceled)
